(19) United States
(12) Patent Application Publication
(10) Pub. No.: US 2026/0027740 A1
(43) Pub. Date: Jan. 29, 2026

(54) RAZOR HANDLE

(71) Applicant: DORCO CO., LTD., Seoul (KR)

(72) Inventors: Ji Hun KI, Seoul (KR); Sang Hun PARK, Seoul (KR); Da Woon HAN, Seoul (KR); Jun Soo CHANG, Seoul (KR)

(21) Appl. No.: 19/342,176

(22) Filed: Sep. 26, 2025

Related U.S. Application Data
(63) Continuation of application No. PCT/KR2024/003963, filed on Mar. 28, 2024.

(30) Foreign Application Priority Data
Mar. 28, 2023 (KR) 10-2023-0040806
May 26, 2023 (KR) 10-2023-0068696
Jul. 21, 2023 (KR) 10-2023-0095160

(51) Int. Cl. B26B 21/52; B26B 21/22

(52) U.S. Cl. CPC B26B 21/521; B26B 21/225

(57) ABSTRACT

A razor handle receives at least one blade in a longitudinal direction and is coupled to a razor cartridge having a connector on one side. The razor handle may include a coupling part detachably coupled to the connector, and a restoring force providing part which moves forward or backward in conjunction with the rotation of the razor cartridge and provides rotational restoring force to the razor cartridge. The coupling part may include a support surface interfered with by the restoring force providing part according to a retreat distance of the restoring force providing part. The restoring force providing part may include a limiting surface which faces the support surface according to a retreat distance and prevents the connector from being separated from the coupling part.

### CROSS REFERENCE TO RELATED APPLICATIONS

This is a continuation application of International Patent Application No. PCT/KR2024/003963 filed on Mar. 28, 2024, which claims priority to Korean patent application No. 10-2023-0040806 filed on Mar. 28, 2023, Korean patent application No. 10-2023-0068696 filed on May 26, 2023, and Korean patent application No. 10-2023-0095160 filed on Jul. 21, 2023, contents of each of which are incorporated herein by reference in their entireties.

### BACKGROUND

### Technical Field

The disclosure relates to a razor handle, and more particularly to a razor handle capable of preventing unintentional separation of a razor cartridge.

### Description of Related Technology

In general, a razor refers to a product for cutting body hair such as fuzz and beard on a face or body, and includes a razor handle for gripping, and a razor cartridge with a razor blade that comes into contact with skin to shave.

### SUMMARY

One aspect is a razor handle that restricts release of the razor cartridge while the razor cartridge is in a pivoted state.

The aspects of the disclosure are not limited to those described herein, and other aspects not mentioned herein may become apparent to those skilled in the art from the following description.

Another aspect is a razor handle coupled with a razor cartridge accommodating at least one blade in a longitudinal direction and having a connector provided on one side, and comprising a coupling portion releasably coupled with the connector, and a restoring force providing portion configured to move forward or backward in conjunction with pivoting of the razor cartridge and to provide a pivot restoring force to the razor cartridge, wherein the coupling portion comprises a support surface that is interfered by the restoring force providing portion based on a retreat distance of the restoring force providing portion, and wherein the restoring force providing portion comprises a restricting surface that faces support surface and restricts release of the coupling between the coupling portion and the connector.

Other details of the disclosure are included in the detailed description and the accompanying drawings.

According to the embodiments of the disclosure, the effects are at least as follows.

By restricting release of the razor cartridge while the razor cartridge is in a pivoted state, unintentional separation of the razor cartridge from the razor handle by the user can be prevented.

The effects of the disclosure are not limited to those described above, and various other effects are included in the foregoing description.

### BRIEF DESCRIPTION OF THE DRAWINGS

FIG. 1 is a perspective view showing a state in which a razor handle according to an embodiment of the present disclosure is coupled with a razor cartridge.

FIG. 2 is a view showing a razor handle according to an embodiment of the present disclosure.

FIG. 3 is a view showing a partial region of the razor handle in a state released from the razor cartridge, according to an embodiment of the present disclosure.

FIG. 4 is a perspective view showing a partial region of FIG. 2.

FIG. 5 is a perspective view showing a state in which the restoring force providing portion is removed from FIG. 4.

FIG. 6 is a perspective view showing the restoring force providing portion of the present disclosure.

FIG. 7 is a bottom perspective view of FIG. 6.

FIG. 8 is a bottom view of FIG. 6.

FIG. 9 is a bottom view of FIG. 4, and FIG. 10 is an enlarged view of a partial region of FIG. 9.

FIG. 11 is a bottom view showing a state in which the support surface of the present disclosure faces a restricting surface, and FIG. 12 is an enlarged view of a partial region of FIG. 11.

FIG. 13 is a view showing a first restricting surface receiving space and a second restricting surface receiving space of the present disclosure.

FIG. 14 is a side view showing a state in which the support surface is received in the first support surface receiving space, together with the razor cartridge.

FIG. 15 is a bottom view of the state in which the razor cartridge is removed from FIG. 14.

FIG. 16 is a side view showing a state in which the support surface is received in the second support surface receiving space, together with the razor cartridge.

FIG. 17 is a bottom view of the state in which the razor cartridge is removed from FIG. 16.

### DETAILED DESCRIPTION

The razor handle is provided with a coupling portion for connecting to the razor cartridge, and the razor cartridge is provided with a connector configured to engage with the coupling portion. The coupling between the razor handle and the razor cartridge may be implemented using various mechanisms, such as a hook coupling, boss coupling, or shell bearing method, allowing releasable engagement. When an external force is unintentionally applied to the razor, such as when the razor is dropped, the razor cartridge may pivot, which can cause the connector of the razor cartridge to disengage from the coupling portion of the razor handle, resulting in the razor cartridge being released from the handle.

Accordingly, there is a need for a razor that can prevent unintended release of the razor cartridge from the razor handle.

The advantages and characteristics of the disclosure and a method for achieving the advantages and characteristics will become more apparent from embodiments described below in detail in conjunction with the accompanying drawings. However, the disclosure is not limited to the disclosed embodiments, but may be implemented in various different ways. The embodiments are provided to only complete the disclosure and to allow those skilled in the art to understand the category of the disclosure. The disclosure is defined by the category of the claims.

In addition, embodiments of the disclosure will be described with reference to cross-sectional views and/or schematic views as idealized exemplary illustrations. Therefore, the illustrations may be varied in shape depending on manufacturing techniques, tolerance, and/or etc. Further, elements in the drawings may be relatively enlarged or reduced for convenience of description. Like numerals refer to like elements throughout.

Below, a razor handle according to embodiments of the disclosure will be described with reference to the accompanying drawings.

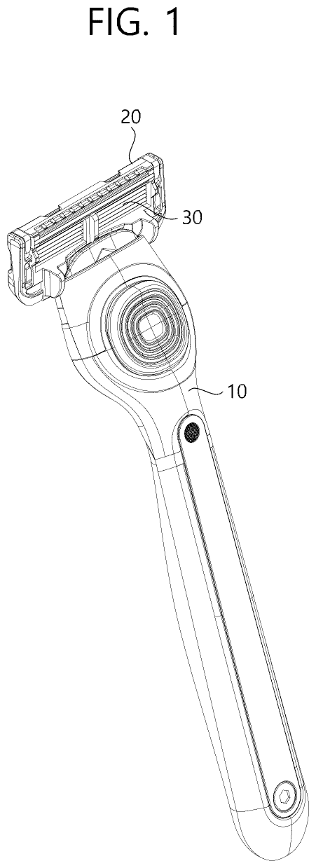

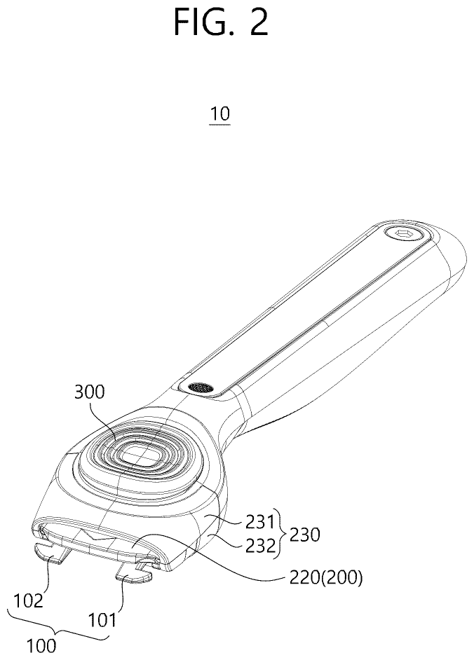

FIG. 1 is a perspective view showing a state in which a razor handle according to an embodiment of the present disclosure is coupled with a razor cartridge, and FIG. 2 is a view showing the razor handle according to an embodiment of the present disclosure.

Referring to FIGS. 1 and 2, the razor cartridge 20 according to an embodiment of the present disclosure directly contacts the user's skin and serves to cut body hair, and may accommodate a blade 30 in the longitudinal direction.

The razor handle 10 is releasably coupled to the razor cartridge 20 and is gripped by the user. It may include a coupling portion 100, a restoring force providing portion 200, and an operation portion 300.

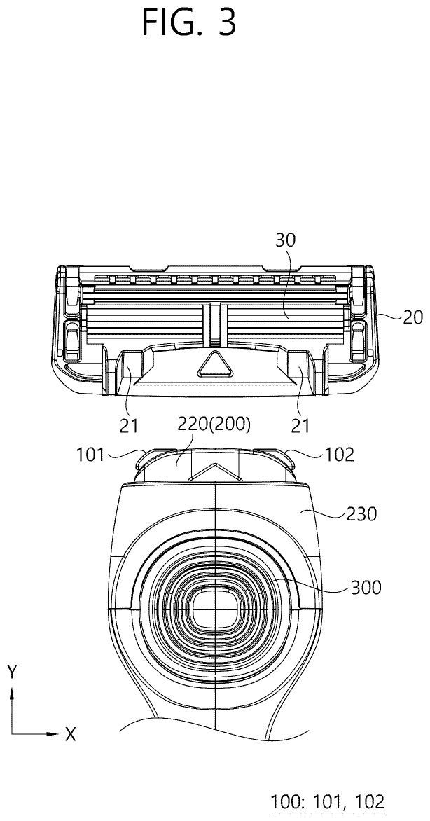

More specifically, the coupling portion 100 of the razor handle 10 may be releasably coupled to a connector 21 formed on one surface of the razor cartridge 20, as shown in FIG. 3. For example, the coupling portion 100 may be releasably coupled to the connector 21 using a hook coupling method, a boss coupling method, or a shell bearing method.

In addition, the razor handle 10 may support the razor cartridge 20 so that it is pivotable. The razor cartridge 20 may pivot with respect to the razor handle 10 about a fixed axis or an axis that moves within a predetermined range.

The restoring force providing portion 200 of the razor handle 10 may provide a restoring force to the pivoted razor cartridge 20, thereby enabling smooth pivoting operation of the razor cartridge 20.

Meanwhile, the operation portion 300 may allow the user to release the razor cartridge 20 from the razor handle 10 as desired. There may be no limitation on the manner in which the user releases the razor cartridge 20 from the razor handle 10 using the operation portion 300.

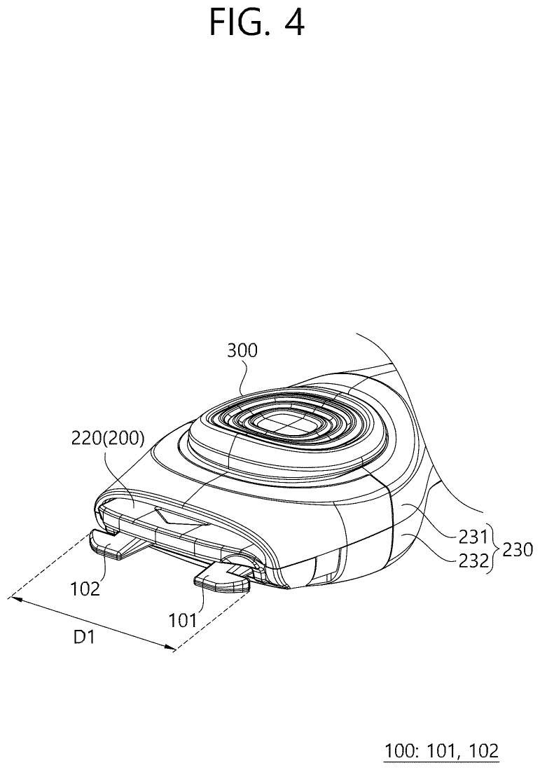

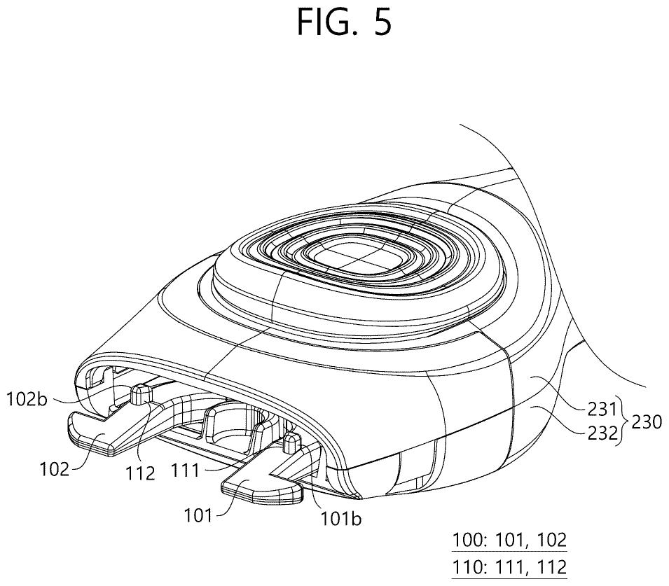

FIG. 3 is a view showing a partial region of the razor handle in a state released from the razor cartridge according to an embodiment of the present disclosure, and FIG. 4 is a perspective view showing a partial region of FIG. 2.

Referring to FIGS. 3 and 4, the coupling portion 100 may be releasably coupled to the connector 21 of the razor cartridge 20.

The coupling portion 100 of the razor handle 10 according to an embodiment of the present disclosure may include a first arm 101 and a second arm 102.

The coupling between the coupling portion 100 and the connector 21 may be achieved as the first arm 101 and the second arm 102 move away from each other, and release between the coupling portion 100 and the connector 21 may be achieved as the first arm 101 and the second arm 102 move closer to each other.

The end of the coupling portion 100 that engages with the connector 21 may have a boss shape, a hook shape, or a shell bearing shape, and the coupling portion 100 may couple with the connector 21 according to the respective shape.

Meanwhile, the first arm 101 and the second arm 102 may be spaced apart from each other in the longitudinal direction. In FIG. 3, the longitudinal direction refers to the x-axis direction. The first arm 101 and the second arm 102 may rotate about one end as a pivot axis, and their other ends may move toward or away from each other in the longitudinal direction. As the other ends of the first arm 101 and the second arm 102 move away from each other in the longitudinal direction, they may engage with the connector 21; conversely, as they move closer to each other, they may release from the connector 21.

More specifically, referring to FIG. 3, a protrusion extending in the y-axis direction may be formed at the other end of each of the first arm 101 and the second arm 102. When the protrusions are inserted into the connector 21 and the other ends of the arms move away from each other in the longitudinal direction, the razor handle 10 and the razor cartridge 20 may be coupled.

In addition, when the other ends of the first arm 101 and the second arm 102 move closer to each other in the longitudinal direction, causing the protrusions extending in the y-axis direction to be spaced apart from the connector 21, the razor handle 10 and the razor cartridge 20 may be released.

This type of coupling method may be applied not only to system razors, where the razor cartridge 20 is replaced by user operation, but also to portable razors that are not designed for user-replaceable cartridges.

Referring to FIG. 4, the operation portion 300 may separate the razor cartridge 20 from the razor handle 10 while they are in a coupled state. The operation portion 300 may move forward to cause the other ends of the first arm 101 and the second arm 102 to move closer together in the longitudinal direction. The operation portion 300 may be located on the upper side of the plunger housing 200, and the top surface of the operation portion 300 may have a frictional surface to enhance grip with the user's finger, though it is not limited thereto.

The user may adjust the spacing between the other ends of the first arm 101 and the second arm 102 via the operation portion 300. When the operation portion 300 is in its original position, the spacing is at a maximum. When the operation portion 300 moves forward (in the positive y-axis direction), the spacing becomes narrower.

Accordingly, since the operation portion 300 allows the user to adjust the spacing between the other ends of the first arm 101 and the second arm 102, the user may operate the operation portion 300 to enable attachment and release between the coupling portion 100 and the connector 21.

FIG. 5 is a perspective view of FIG. 4 in a state where the restoring force providing portion is removed.

Referring to FIGS. 3 and 5, the coupling portion 100 may include a support surface 110 that is interfered with by the restoring force providing portion 200 depending on the retraction distance of the restoring force providing portion 200.

In FIG. 3, the front-rear direction of the restoring force providing portion 200 indicates its direction of movement. The front direction refers to the direction toward the razor cartridge 20 with respect to the restoring force providing portion 200, and the rear direction refers to the direction away from the razor cartridge 20.

The interference by the restoring force providing portion 200 may refer to a restriction of movement of the support surface 110 during release of the coupling portion 100 from the connector 21.

Referring to FIG. 5, the support surface 110 is the portion facing a restricting surface 210 of the restoring force providing portion 200, which will be described later, and may include a first support surface 111 and a second support surface 112.

The support surface 110 may be formed on at least one of the first arm 101 or the second arm 102. For example, the first support surface 111 may be formed on the first arm 101, or the second support surface 112 may be formed on the second arm 102. Alternatively, the first support surface 111 may be formed on the first arm 101, and the second support surface 112 may be formed on the second arm 102.

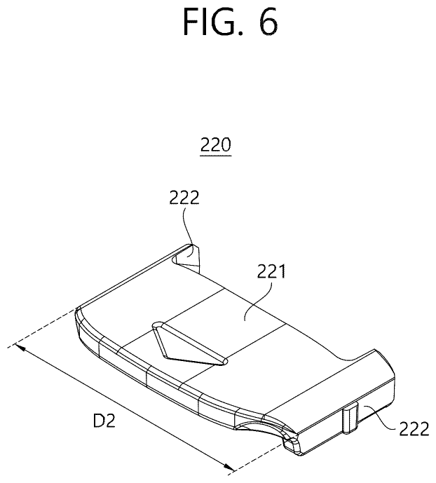

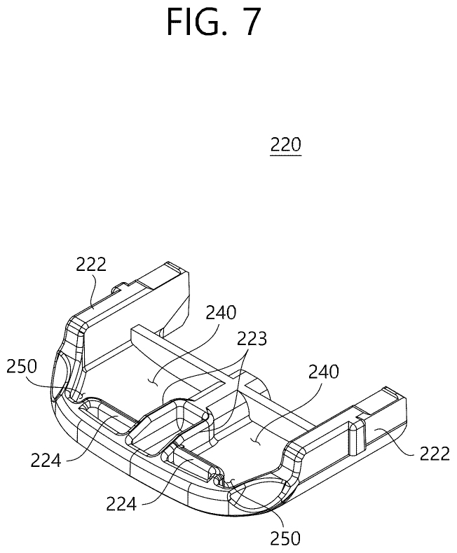

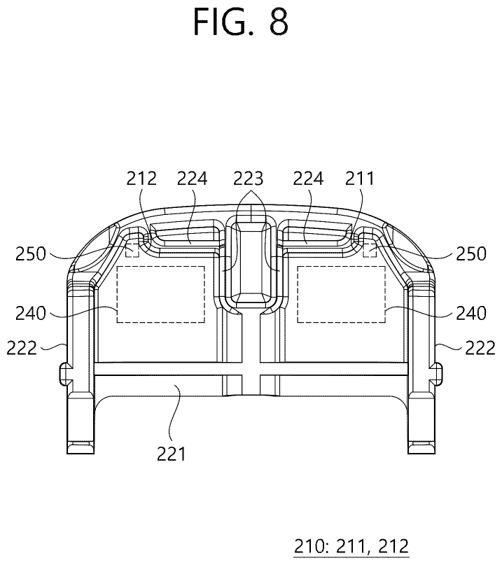

FIG. 6 is a perspective view showing the restoring force providing portion of the present disclosure, FIG. 7 is a bottom perspective view of FIG. 6, and FIG. 8 is a bottom view of FIG. 6.

Referring to FIGS. 6 through 8, a plunger 220 may include an upper cover 221, sidewalls 222, a first protrusion 223, and a second protrusion 224. Although FIGS. 6 through 8 illustrate both the first protrusion 223 and the second protrusion 224, either one may be selectively included as long as it can restrict movement of the support surface 110.

The upper cover 221 is a portion that covers at least a part of the first arm 101 and the second arm 102. The sidewalls 222 are portions extending downward from both sides of the upper cover 221 to accommodate the first arm 101 and the second arm 102. The first protrusion 223 is formed to protrude from one surface of the upper cover 221 between the first arm 101 and the second arm 102, and the second protrusion 224 extends in the longitudinal direction from the first protrusion 223.

Referring to FIG. 8, a first support surface receiving space 240 and a second support surface receiving space 250 may be formed on one surface of the plunger 220. Specifically, the first support surface receiving space 240 may be formed between the sidewall 222 and the first protrusion 223, and the second support surface receiving space 250 may be formed between the sidewall 222 and the second protrusion 224.

The restricting surface 210 that faces the support surface 110 and restricts its movement may be provided on one surface of the plunger 220. When the support surface 110 includes the first support surface 111 formed on the first arm 101 and the second support surface 112 formed on the second arm 102, the restricting surface 210 may include a first restricting surface 211 and a second restricting surface 212.

The first restricting surface 211 may be formed on one side of the second protrusion 224. Here, “one side” of the second protrusion 224 refers to the longitudinal end portion of the second protrusion 224, as shown in FIG. 8.

The second restricting surface 212 may be formed on the other side of the second protrusion 224. Here, the “other side” of the second protrusion 224 refers to a longitudinal end portion of the second protrusion 224 opposite to the one side, as shown in FIG. 8.

Meanwhile, the relative position between the support surface 110 and the restricting surface 210 of the restoring force providing portion 200 may change. As the restoring force providing portion 200 moves forward or backward in conjunction with the pivoting of the razor cartridge 20, the relative position between the support surface 110 and the restricting surface 210 of the restoring force providing portion 200 may vary. When the support surface 110 faces the restricting surface 210, its movement may be restricted. If the movement of the support surface 110 is restricted by the restricting surface 210, the coupling portion 100 is not released from the connector 21, thereby maintaining the engagement between the razor cartridge 20 and the razor handle 10.

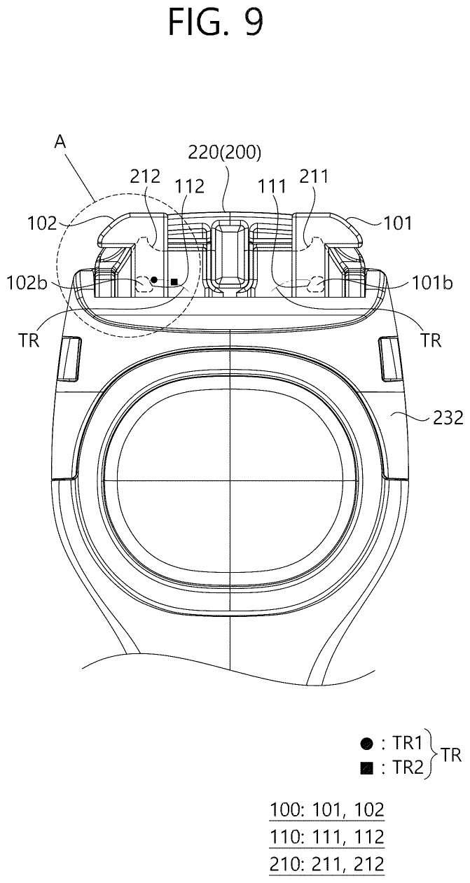

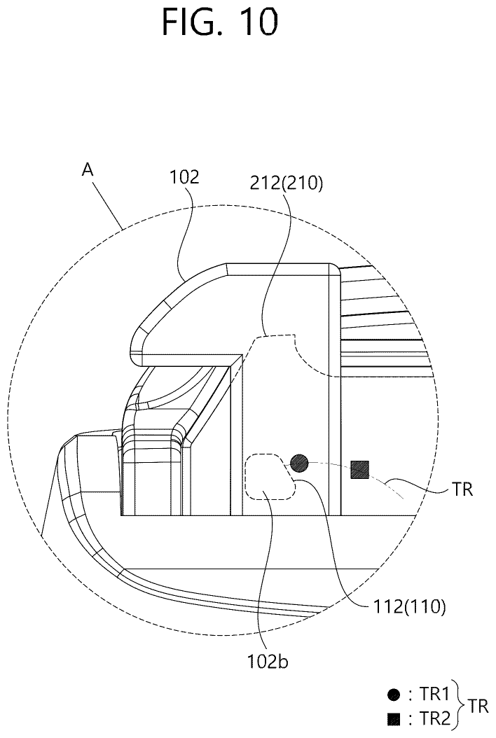

FIG. 9 is a bottom view of FIG. 4, and FIG. 10 is an enlarged view of a region A in FIG. 9.

Referring to FIGS. 9 and 10, the support surface 110 may move along a trajectory TR during the attachment or release of the coupling portion 100 to or from the connector 21. The trajectory TR refers to the movement path of the support surface 110 during the attachment or release of the coupling portion 100 to or from the connector 21. The trajectory TR may include a coupling position TR1 and a release position TR2. The coupling position TR1 refers to the position of the support surface 110 when the coupling portion 100 is coupled to the connector 21, and the release position TR2 refers to the position of the support surface 110 when the coupling portion 100 is in a releasable state from the connector 21.

The coupling position TR1 and the release position TR2 are two arbitrary points along the trajectory TR and may not necessarily be the endpoints of the trajectory.

The trajectory TR shown in FIGS. 9 and 10 represents the trajectory when the razor cartridge 20 is in a rest position. The rest position refers to a state in which the razor cartridge 20 is coupled to the razor handle 10 and is not pivoted.

In the rest position, the restricting surface 210 is positioned spaced apart from the trajectory TR. Therefore, in the rest position, the restricting surface 210 does not restrict movement of the support surface 110.

When the razor cartridge 20 is in the rest position, the support surface 110 may move from the coupling position TR1 to the release position TR2 in response to user operation. As the other ends of the first arm 101 and the second arm 102 move closer together by user operation, the first support surface 111 and the second support surface 112 formed on the first arm 101 and the second arm 102, respectively, may move from the coupling position TR1 to the release position TR2 along the trajectory TR.

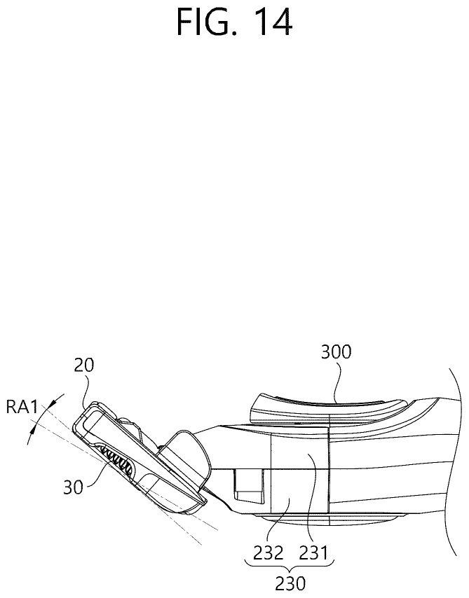

Additionally, when the razor cartridge 20 is pivoted from the rest position within a predetermined angular range and located in a first region RA1 (see FIG. 14), the first support surface 111 and the second support surface 112 formed on the first arm 101 and the second arm 102 may move between the coupling position TR1 and the release position TR2. That is, by moving the first support surface 111 and the second support surface 112 from the release position TR2 to the coupling position TR1, the coupling portion 100 may be attached to the connector 21. Detailed descriptions related to this are provided later in the explanation of the restoring force providing portion 200.

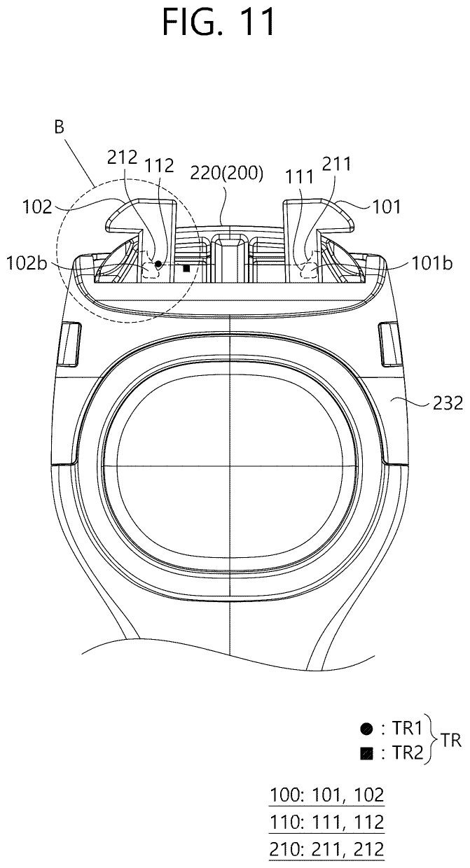

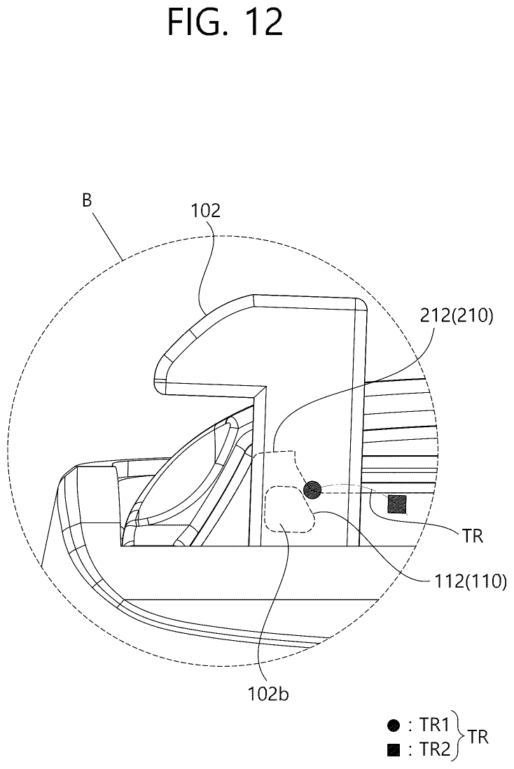

FIG. 11 is a bottom view showing a state in which the support surface of the present disclosure faces the restricting surface, and FIG. 12 is an enlarged view of region B in FIG. 11.

Referring to FIGS. 11 and 12, when the razor cartridge 20 is pivoted from the rest position and the restoring force providing portion, for example, the plunger, is retracted by a predetermined distance or more, the movement of the support surface 110 may be restricted by the restricting surface 210. In this case, as the relative position between the restricting surface 210 and the support surface 110 changes, the restricting surface 210 may be located between the coupling position TR1 and the release position TR2. When the support surface 110 faces the restricting surface 210 positioned between the coupling position TR1 and the release position TR2 and its movement is restricted, the support surface 110 can no longer move to the release position TR2 from the coupling position TR1. Since the support surface 110 cannot move to the release position TR2, the engagement between the coupling portion 100 and the connector 21 is maintained without being released.

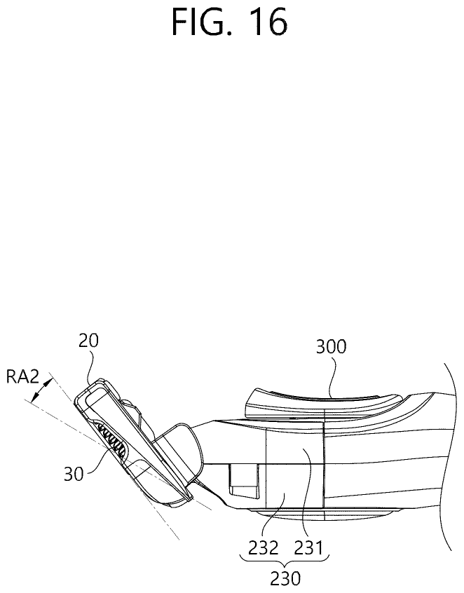

Additionally, when the razor cartridge 20 is located in a second region RA2 (see FIG. 16) where it has pivoted beyond a predetermined angle from the rest position, the first support surface 111 and the second support surface 112 formed on the first arm 101 and the second arm 102, respectively, cannot move from the coupling position TR1 to the release position TR2. Details related to this will be described later in the explanation of the restoring force providing portion 200.

Referring to FIG. 5, the first arm 101 may include a first projection 101b, and the second arm 102 may include a second projection 102b. The first projection 101b and the second projection 102b may be formed as outward projections. The first projection 101b may include the first support surface 111, and the second projection 102b may include the second support surface 112. That is, the first support surface 111 may form a surface of the first projection 101b, and the second support surface 112 may form a surface of the second projection 102b.

Meanwhile, the coupling portion 100 may include a support region formed as a projection or a depression from a surface. As shown in FIG. 5, the support region may be formed as a projecting bump or as a recessed groove. Similar to the first support surface 111 and the second support surface 112 formed on the first arm 101 and the second arm 102, the support surface 110 formed on a surface of the support region may move from the coupling position TR1 to the release position TR2, and such movement may be restricted by the restricting surface 210.

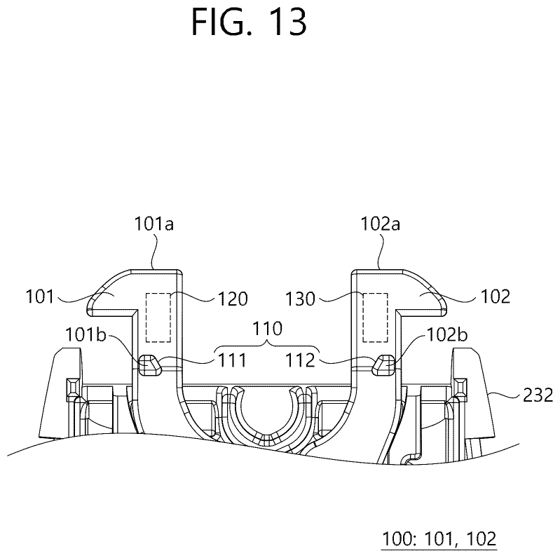

FIG. 13 is a view showing the first restricting surface receiving space and the second restricting surface receiving space according to the present disclosure.

Referring to FIG. 13, the first arm 101 may form at least a portion of the first restricting surface receiving space 120. The first restricting surface receiving space 120 may be a space formed between the first support surface 111 and a distal end portion 101a of the first arm 101.

According to an embodiment of the present disclosure, when the first arm 101 is released from the connector 21, the first restricting surface 211 of the restoring force providing portion 200 may be located within the first restricting surface receiving space 120 or positioned in front of the first restricting surface receiving space 120. That is, when the razor cartridge 20 is in the rest position, as the distance between the other ends of the first arm 101 and the second arm 102 is reduced by forward movement of the operation portion 300, the first restricting surface 211 may be located within or in front of the first restricting surface receiving space 120. When the first restricting surface 211 is located within or in front of the first restricting surface receiving space 120, the first restricting surface 211 does not face the first support surface 111, and therefore, the movement of the first support surface 111 may not be restricted by the first restricting surface 211.

Similarly, the second arm 102 may form at least a portion of the second restricting surface receiving space 130. The second restricting surface receiving space 130 may be a space formed between the second support surface 112 and a distal end portion 102a of the second arm 102.

According to an embodiment of the present disclosure, when the second arm 102 is released from the connector 21, the second restricting surface 212 of the restoring force providing portion 200 may be located within the second restricting surface receiving space 130 or positioned in front of the second restricting surface receiving space 130. That is, when the razor cartridge 20 is in the rest position, as the distance between the other ends of the first arm 101 and the second arm 102 is reduced by forward movement of the operation portion 300, the second restricting surface 212 may be located within or in front of the second restricting surface receiving space 130. When the second restricting surface 212 is located within or in front of the second restricting surface receiving space 130, the second restricting surface 212 does not face the second support surface 112, and therefore, the movement of the second support surface 112 may not be restricted by the second restricting surface 212.

Consequently, when the first arm 101 and the second arm 102 are released from the connector 21, the first restricting surface 211 may be located inside or in front of the first restricting surface receiving space 120, and simultaneously, the second restricting surface 212 may be located inside or in front of the second restricting surface receiving space 130.

Meanwhile, if the restricting surface 210 and the support surface 110 do not face each other, the restricting surface 210 is not necessarily limited to being positioned in front of the restricting surface receiving spaces 120 and 130, and the restricting surface 210 may also be located behind the restricting surface receiving spaces 120 and 130.

That is, as long as the movement of the support surface 110 can be restricted by the restricting surface 210 when the restricting surface 210 and the support surface 110 face each other, there may be no limitation on the positions of the restricting surface 210, the support surface 110, and the restricting surface receiving spaces 120 and 130, nor on their positional relationships.

Referring back to FIGS. 3 and 4, the restoring force providing portion 200 is configured to move forward or backward in conjunction with the pivoting of the razor cartridge 20, providing a pivot restoring force, and may include a plunger 220.

The restoring force providing portion 200 of the razor handle 10 according to an embodiment of the present disclosure is not limited to including the plunger 220 and may be configured to provide the pivot restoring force by including a cantilever structure and/or a rubber member having elasticity. For convenience of explanation, the following description will be based on an example in which the restoring force providing portion 200 includes the plunger 220.

The plunger 220 may be supported by an elastic member (not shown) and may advance or retract in conjunction with the pivoting of the razor cartridge 20 to provide the pivot restoring force. When the coupling portion 100 includes the first arm 101 and the second arm 102, the plunger 220 may cover at least part of the first arm 101 and the second arm 102.

Meanwhile, the plunger 220 according to an embodiment of the present disclosure may be a cover-type plunger. The ratio of the longitudinal width D2 (see FIG. 6) of the plunger 200 to the longitudinal outer distance D1 (see FIG. 4) between the distal ends of the first arm 101 and the second arm 102 may be between 0.8 and 1.2.

However, the type and specific shape of the plunger 200 are not limited as long as it can provide the pivot restoring force to the razor cartridge 20.

Meanwhile, the plunger 220 may slide in conjunction with the pivoting of the razor cartridge 20. The plunger 220 supported by an elastic member can provide the pivot restoring force to the razor cartridge 20.

Further, referring to FIG. 4, the plunger housing 230 forms a space accommodating the plunger 220 and the coupling portion 100, and may support the plunger 220 so that it can slide. The plunger housing 230 may include an upper housing 231 and a lower housing 232. The upper housing 231 and the lower housing 232 may form a space accommodating the plunger 220 and the coupling portion 100.

Referring again to FIGS. 10(a) and 10(b), depending on the retraction distance of the restoring force providing portion 200, for example, the plunger 220, the first restricting surface 211 may face the first support surface 111 and restrict movement of the first support surface 111 to the release position TR2 along the trajectory TR. Accordingly, the first restricting surface 211 can prevent the first arm 101 from being separated from the connector 21.

Similarly, depending on the retraction distance of the plunger 220, the second restricting surface 212 may face the second support surface 112 and restrict movement of the second support surface 112 to the release position TR2 along the trajectory TR. Accordingly, the second restricting surface 212 can prevent the second arm 102 from being separated from the connector 21.

As such, the relative position of the restricting surface 210 with respect to the support surface 110 may change depending on the retraction distance of the plunger 220. As the relative position between the restricting surface 210 and the support surface 110 changes, the restricting surface 210 may be positioned on the trajectory TR of the support surface 110. Specifically, as the plunger 220 retracts in conjunction with the pivoting of the razor cartridge 20, the restricting surface 210 may be positioned between the coupling position TR1 and the release position TR2 on the trajectory TR. In this case, as the support surface 110 faces the restricting surface 210, the support surface 110 may no longer move to the release position TR2. Accordingly, the coupling portion 100 and the connector 21 may not be separated.

Meanwhile, the movement restriction of the support surface 110 on the trajectory TR by the restricting surface 210 may operate depending on the retraction distance of the plunger 220 or depending on the pivoting angle of the razor cartridge 20.

Regarding the movement restriction of the support surface 110 on the trajectory TR in relation to the pivoting angle of the razor cartridge 20, when the razor cartridge 20 is pivoted beyond a predetermined angle from the rest position, the restricting surface 210 may be positioned on the trajectory TR of the support surface 110, facing the support surface 110 and restricting its movement.

Meanwhile, the restoring force providing portion 200 may include a restricting region protruding from or recessed into a surface. The restricting region may be formed in a protruding shape such as a projection or a recessed shape such as a groove. Like the first restricting surface 211 formed on one side of the second protrusion 224 and the second restricting surface 212 formed on the opposite side of the second protrusion 224 mentioned above, the restricting surface 210 formed on one surface of the restricting region may face the support surface 110 and restrict movement along the trajectory TR of the support surface 110.

The restricting region is not limited to being in the form of a projection or groove, and as long as the interaction between the restricting surface 210 and the support surface 110 can restrict the separation between the razor cartridge 20 and the razor handle 10, there may be no limitation on its shape or position, such as being formed on the outer surface of the restoring force providing portion 200.

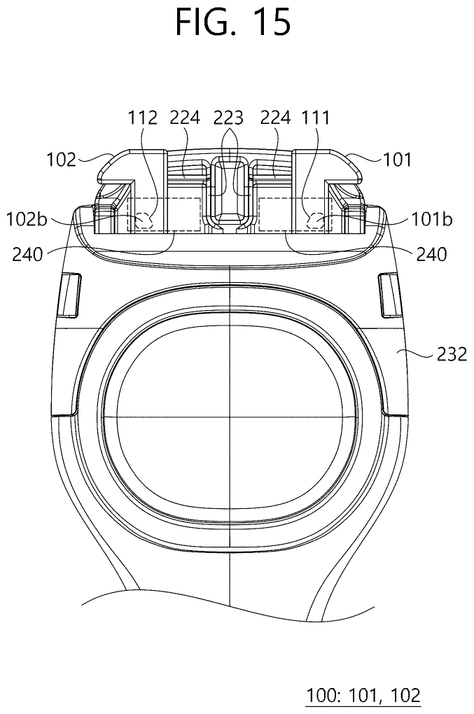

FIG. 14 is a side view illustrating the support surface of the present disclosure accommodated in the first support surface receiving space together with the razor cartridge, and FIG. 15 is a bottom view illustrating a state in which the razor cartridge is removed from FIG. 14.

Referring to FIGS. 8 and 14, the first support surface receiving space 240 may be a space in which the support surface 110 is accommodated when the razor cartridge 20 is positioned in the first section RA1 pivoted within a predetermined angle range from the rest position.

The first section RA1 may be a section in which the movement of the support surface 110 is not restricted by the restricting surface 210.

The range of the pivot angle of the razor cartridge 20 forming the first section RA1 is from 0 degrees to a first angle. According to one embodiment of the present disclosure, the first angle may be from 18° to 36°, preferably from 25° to 32°.

As the first angle increases, the range of pivot angles at which the razor cartridge 20 and the razor handle 10 can be initially coupled may increase. Accordingly, the user can easily attach the razor cartridge 20 and the razor handle 10 within a wider angle range.

Therefore, if the first section RA1 where the movement of the support surface 110 is not restricted by the restricting surface 210 can be formed, there may be no limitation on the first angle, and the first angle may correspond to the maximum pivot angle of the razor cartridge 20 in the razor.

Referring to FIG. 15, when the razor cartridge 20 is positioned in the first section RA1 and the support surface 110 is located in the first support surface receiving space 240, movement of the support surface 110 along the trajectory TR may not be restricted by the restricting surface 210. When the support surface 110 is located within the first support surface receiving space 240, the support surface 110 may move between the coupling position TR1 and the release position TR2. Since the support surface 110 can move from the release position TR2 to the coupling position TR1, the coupling portion 100 can be mounted to the connector 21.

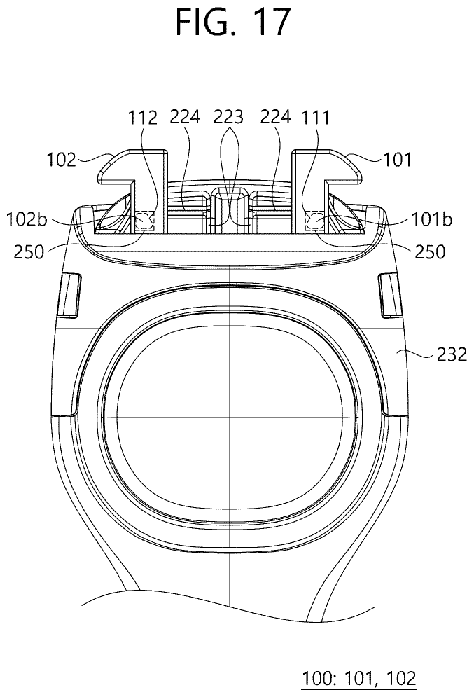

FIG. 16 is a side view illustrating the support surface of the present disclosure accommodated in the second support surface receiving space together with the razor cartridge, and FIG. 17 is a bottom view illustrating the state where the razor cartridge is removed from FIG. 16.

Referring to FIGS. 8 and 16, the second support surface receiving space 250 may be a space in which the support surface 110 is accommodated when the razor cartridge 20 is positioned in the second section RA2 pivoted beyond a predetermined angle from the rest position.

The second section RA2 may be a section where movement of the support surface 110 is restricted by the restricting surface 210.

The range of the pivot angle of the razor cartridge 20 forming the second section RA2 may be from the first angle to a second angle. The second angle has a larger value than the first angle. The difference between the second angle and the first angle, i.e., the second section RA2, may be from 5° to 18°.

When the range of pivot angles between the first angle and the second angle where the second section RA2 is formed (see FIG. 16) increases, the section where the movement of the support surface 110 is restricted by the restricting surface 210 increases, thereby maximizing the effect of preventing unintended separation of the razor handle 10 and the razor cartridge 20 due to external shocks.

If the second section RA2, where the movement of the support surface 110 is restricted by the restricting surface 210, can be formed, there may be no limitation on the second angle, and the second angle may exceed the maximum pivot angle of the razor cartridge 20 in the razor.

Referring to FIG. 17, when the razor cartridge 20 is positioned in the second section RA2 and the support surface 110 is located in the second support surface receiving space 250, movement of the support surface 110 along the trajectory TR may be restricted by the restricting surface 210. When the support surface 110 is located within the second support surface receiving space 250, the release position TR2 on the trajectory TR may not be located within the second support surface receiving space 250, and the support surface 110, by facing the restricting surface 210, may be restricted from moving along the trajectory TR from the coupling position TR1 to the release position TR2. Therefore, since the support surface 110 cannot move from the coupling position TR1 to the release position TR2, the coupling portion 100 and the connector 21 may not be separated.

Hereinafter, the first external force and the second external force refer to external forces that pivot the razor cartridge 20 relative to the razor handle 10.

When the razor cartridge 20 is positioned in the first section RA1, the first external force acting on the razor cartridge 20 is smaller than the second external force acting on the razor cartridge 20 when positioned in the second section RA2. Even when the second external force, which is greater than the first external force, acts on the razor cartridge 20, the razor cartridge 20 and the razor handle 10 may not separate. Even if an external force greater than the second external force acts on the razor cartridge 20, the razor cartridge 20 and the razor handle 10 may not separate. Referring to FIGS. 8 and 13, the longitudinal width of the second support surface receiving space 250 may be narrower than that of the first support surface receiving space 240.

The second support surface receiving space 250, which has a relatively smaller longitudinal width, can prevent separation of the razor cartridge 20 from the razor handle 10 by restricting the spacing distance between the distal ends of the first arm 101 and the second arm 102.

As described above, the razor handle 10 according to one embodiment of the present disclosure may restrict separation of the razor cartridge 20 while the razor cartridge 20 is pivoted, so that even if the razor receives unintended external force due to falling or the like, the razor cartridge 20 may not separate from the razor handle 10.

Although exemplary embodiments of the disclosure have been described with reference to the accompanying drawings, the configurations described in the embodiments and depicted in the drawings are merely the most preferred embodiments of the disclosure and do not represent all the technical ideas of the disclosure, and thus it should be understood that there may be various equivalents and variations capable of replacing the embodiments at the time of this application. Accordingly, the embodiments described above are illustrative and not restrictive in all aspects. The scope of the disclosure is defined by the appended claims rather than the foregoing detailed description, and all changes or modifications derived from the meaning and scope of the appended claims and their equivalents are construed as falling within the scope of the disclosure.

What is claimed is:

1. A razor handle configured to be coupled with a razor cartridge accommodating at least one blade in a longitudinal direction and having a connector provided on one side, the razor handle comprising:
a coupling portion releasably coupled with the connector; and
a restoring force providing portion configured to move forward or backward in conjunction with pivoting of the razor cartridge and to provide a pivot restoring force to the razor cartridge,
wherein the coupling portion comprises a support surface that is interfered by the restoring force providing portion based on a retreat distance of the restoring force providing portion, and
wherein the restoring force providing portion comprises a restricting surface whose relative position to the support surface changes based on the retreat distance to allow or restrict release of the coupling between the coupling portion and the connector.

2. The razor handle of claim 1, wherein the support surface moves along a trajectory during release of the coupling portion from the connector, and
wherein the restricting surface is positioned on the trajectory based on the retreat distance of the restoring force providing portion to restrict movement of the support surface along the trajectory.

3. The razor handle of claim 2, wherein the trajectory comprises a coupling position where the support surface is located when the coupling portion is coupled to the connector, and a release position where the support surface is located when the coupling portion is releasable from the connector, and
wherein the restricting surface is positioned between the coupling position and the release position when the restoring force providing portion is retreated beyond a predetermined distance, thereby restricting the support surface from moving from the coupling position to the release position.

4. The razor handle of claim 3, wherein, when the razor cartridge is in a rest position, the restricting surface is spaced apart from the trajectory so that the support surface can move from the coupling position to the release position.

5. The razor handle of claim 1, wherein the coupling portion comprises a first arm and a second arm spaced apart from each other in the longitudinal direction.

6. The razor handle of claim 5, wherein the support surface comprises a first support surface formed on the first arm and a second support surface formed on the second arm, and
wherein the restricting surface comprises:
a first restricting surface facing the first support surface based on the retreat distance of the restoring force providing portion to prevent the first arm from being released from the connector; and
a second restricting surface facing the second support surface based on the retreat distance of the restoring force providing portion to prevent the second arm from being released from the connector.

7. The razor handle of claim 6, wherein the first arm comprises a first projection protruding therefrom, and the first support surface is formed on one side of the first projection, and
wherein the second arm comprises a second projection protruding therefrom, and the second support surface is formed on one side of the second projection.

8. The razor handle of claim 1, wherein the coupling portion comprises a support region protruding or recessed from one side, and the support surface is formed on one side of the support region.

9. The razor handle of claim 1, wherein the restoring force providing portion includes a restricting region protruding or recessed from one side, and the restricting surface is formed on one side of the restricting region.

10. The razor handle of claim 1, wherein the restoring force providing portion comprises a plunger advancing or retracting in conjunction with pivoting of the razor cartridge and providing the pivot restoring force, and
wherein the restricting surface is provided on one side of the plunger.

11. The razor handle of claim 10, wherein the coupling portion comprises a first arm and a second arm spaced apart in the longitudinal direction, and
wherein the plunger is configured to cover at least a portion of the first arm and the second arm.

12. A razor handle configured to be coupled with a razor cartridge accommodating at least one blade in a longitudinal direction and having a connector provided on one side, the razor handle comprising:
a coupling portion releasably coupled with the connector; and
a restoring force providing portion moving in conjunction with pivoting of the razor cartridge and providing a pivot restoring force to the razor cartridge,
wherein the coupling portion comprises a support surface moving along a trajectory during release from the connector, and
wherein the restoring force providing portion comprises a restricting surface positioned on the trajectory when the razor cartridge is pivoted by a predetermined angle or more from a rest position to restrict movement of the support surface.

13. A razor handle configured to be releasably coupled with a razor cartridge accommodating at least one blade in a longitudinal direction and having a connector on one side, the razor handle including:
a coupling portion releasably coupled with the connector and including a support surface; and
a restoring force providing portion providing a pivot restoring force to the razor cartridge,
wherein the restoring force providing portion comprises:
a first support surface receiving space accommodating the support surface when the razor cartridge is pivoted within a predetermined angle range from a rest position in a first section; and
a second support surface receiving space accommodating the support surface when the razor cartridge is pivoted by a predetermined angle or more from the rest position in a second section,
wherein the coupling portion is releasable from the connector when the support surface is positioned in the first support surface receiving space, and
wherein the coupling portion is not releasable from the connector when the support surface is positioned in the second support surface receiving space.

14. The razor handle of claim 13, wherein, when the support surface is positioned in the first support surface receiving space, the support surface can move between a coupling position where the coupling portion is coupled to the connector and a release position where the coupling portion is releasable from the connector, and
wherein, when the support surface is positioned in the second support surface receiving space, movement of the support surface from the coupling position to the release position is restricted.

15. The razor handle of claim 14, wherein the release position is not positioned within the second support surface receiving space when the support surface is positioned within the second support surface.

16. The razor handle of claim 13, wherein the restoring force providing portion comprises a plunger sliding in conjunction with pivoting of the razor cartridge and providing the pivot restoring force, and
wherein the first support surface receiving space and the second support surface receiving space are formed on one side of the plunger.

17. The razor handle of claim 16, wherein the coupling portion comprises a first arm and a second arm spaced apart in the longitudinal direction, and
wherein the plunger comprises:
an upper cover covering at least a portion of the first arm and the second arm;
side walls extending downward from both sides of the upper cover to accommodate the first arm and the second arm;
a first protrusion protruding from one side of the upper cover between the first arm and the second arm; and
a second protrusion extending longitudinally from the first protrusion,
wherein the first support surface receiving space is formed between the side walls and the first protrusion, and
wherein the second support surface receiving space is formed between the side walls and the second protrusion.
